(19) United States
(12) Patent Application Publication
(10) Pub. No.: US 2026/0366435 A1
(43) Pub. Date: Nov. 19, 2026

(54) DEVICE FOR GUIDING A SHAFT AND FOR COOLING A BEARING FOR A GAS GENERATOR

(71) Applicant: SAFRAN POWER UNITS, Toulouse (FR)

(72) Inventors: Romain QUINTON, MOISSY-CRAMAYEL (FR); Stéphane CHEVALIER, MOISSY-CRAMAYEL (FR); Serge Marie Gabriel COT, MOISSY-CRAMAYEL (FR)

(73) Assignee: SAFRAN POWER UNITS, Toulouse (FR)

(21) Appl. No.: 19/148,049

(22) PCT Filed: Jan. 15, 2024
(86) PCT No.: PCT/FR2024/050056

§ 371 Date: Jul. 15, 2025

(30) Foreign Application Priority Data
Jan. 17, 2023 (FR) FR2300430

(51) Int. Cl. F01D 25/12; F01D 25/16; F01D 25/18

(52) U.S. Cl. CPC F01D 25/125; F01D 25/162; F01D 25/18; F05D 2240/50; F05D 2260/98

(57) ABSTRACT

A device for guiding a shaft about an axis for a gas generator, the device having: a rolling bearing; a circuit for lubricating the rolling bearing; an annular casing that extends around the bearing, including an inner recess for mounting the outer race; and a circuit for cooling the outer race of the bearing. The circuit can include at least one annular fluid-feed cavity formed in the wall thickness of the casing, at least one annular fluid-discharge cavity formed in the wall thickness of the casing, and an annular system for cooling the outer race which is connected, respectively, to the feed and discharge cavities.

### TECHNICAL FIELD OF THE INVENTION

This invention relates to a device for guiding a shaft and cooling a bearing for a gas generator, such as a turbomachine or an auxiliary power unit.

### TECHNICAL BACKGROUND

The prior art comprises in particular the documents FR-A1-3 098 560, CN-B-110 905 653 and DE-A1-10 2016 211569.

In the present application, a gas generator is taken to mean a machine which successively comprises at least one compressor, a combustion chamber and at least one turbine. Air is compressed in the compressor, mixed with fuel and burnt in the combustion chamber. The combustion gases thus generated are expanded in the at least one turbine which drives the rotor of the at least one compressor. The two rotors may be secured to each other.

There are several gas generator applications and technologies. The gas generator may, for example, be a turbomachine, in particular for an aircraft, and comprise one or more bodies, each body comprising a shaft connecting a compressor rotor to a turbine rotor. The turbomachine can be a turbojet engine, a turboprop engine, etc. The gas generator can also be an auxiliary power unit, also known as an APU (which stands for Auxiliary Power Unit), which can be fitted to an aircraft, for example.

The rotors and shafts of a gas generator are centred and guided in rotation by bearings which each comprise two rings, an inner and an outer ring respectively, between which rolling elements such as balls or rollers, for example, are mounted.

These guide bearings need to be lubricated during operation and are therefore associated with a lubrication circuit which generally uses oil.

These guide bearings must also be cooled to dissipate the heat energy generated during operation. There are several ways of achieving this.

One solution is to use the lubricating oil to cool the bearing. The bearing lubrication circuit is then a lubrication and cooling circuit for the bearing.

However, this solution has its drawbacks. The circuit requires dedicated systems such as a pump, a tank, a filter and an air/oil exchanger to remove the heat from the oil to the outside. The volume, flow rate, temperature and calories to be evacuated that characterise this lubrication will determine the power of the pump, the size of the reservoir, the heat exchanger and the filter, as well as conditioning the use of certain materials (with regard to the temperatures reached by the oil).

Another solution is to use a lubrication and cooling circuit for the bearing that uses only fuel instead of oil. This last solution is not optimal because the fuel used to lubricate the bearing is likely to be polluted by particles generated by wear on the bearing. The polluted fuel is unsuitable for the combustion chamber injectors (because it risks clogging them) and must therefore be discharged into the exhaust gases without being used for propulsion.

Another solution is to provide two separate, independent circuits for lubricating and cooling the bearing. The lubrication circuit can use oil and the cooling circuit can use fuel, avoiding contact with the rolling elements. The fuel used to cool the bearing is heated by heat exchange with the bearing and can then be redirected to the combustion chamber for propulsion purposes, thereby extending the flight envelope and increasing payload capacity.

The invention provides an improvement that avoids at least some of the disadvantages of the previous technique, and is simple, effective and economical.

### SUMMARY OF THE INVENTION

The invention relates to a device for guiding a shaft about an axis and for cooling a bearing for a gas generator, comprising:
a rolling bearing centred on the axis and comprising an inner ring, an outer ring and rolling elements arranged between these rings,
a circuit for lubricating the rolling bearing,
an annular casing which extends around the bearing and which comprises an internal recess for mounting the outer ring, this casing comprising a wall thickness measured radially with respect to the axis, and
a circuit for cooling the outer ring of the bearing, which is independent of the lubrication circuit, characterized in that the cooling circuit comprises:
at least one cooling fluid supply duct and at least one cooling fluid discharge duct, formed in the wall thickness of the casing,
at least one annular fluid supply cavity extending around the axis and formed in the wall thickness of the casing, this annular cavity being connected to said at least one supply duct,
at least one annular fluid discharge cavity extending around the axis and formed in the wall thickness of the casing, this annular cavity being connected to said at least one discharge duct, and
an annular system for cooling the outer ring which is connected respectively to the supply and discharge cavities, this system comprising at least one fluid passage which extends along the axis and opens with a radial component inwards into the recess of the outer ring.

One of the particularities of the guiding device according to the invention is that its lubrication and cooling circuits are independent. In the present application, these circuits are independent in that the fluid used to cool the bearing is not used to lubricate it (although the fluid used to lubricate the bearing may be used to cool it). The lubricating and cooling fluids are advantageously different. The fluids are not intended to mix particularly at the level of the bearing.

Another one of the particularities of the device is that the cooling circuit of the bearing is essentially formed within the thickness of the casing, and is therefore optimised in terms of overall dimension. This thickness is not necessarily constant and can vary along the axis.

Finally, another one of the advantageous particularities of the device is that the fluid passage(s) open into the internal recess of the outer ring and extend in the axial direction. The opening of the passage(s) in the internal recess allows the cooling fluid to be in direct contact with the outer ring, which optimizes its cooling by direct contact and convection of this fluid with the outer ring. The axial component of the orientation of the passage(s) allows the cooling fluid to have a limited travel on contact with the outer ring and therefore reduces the risk of heating the fluid on this contact. This orientation is preferred, for example, to a circumferential orientation around the ring, in which the fluid could heat up and not effectively cool the ring all the way round.

The device according to the invention may comprise one or more of the following characteristics, taken alone or in combination with each other:
the system comprises a single fluid passage which has an annular shape about the axis;
the single passage is empty;
the single passage is filled with a cellular structure; this cellular structure is preferably a three-dimensional lattice structure, for example of the type described in the application FR-A1-3 096 110 or FR-A1-3 100 728;
the single passage is connected to the supply cavity by a first series of orifices formed in the casing, and to the discharge cavity by a second series of orifices formed in the casing;
the single passage comprises an annular bottom which faces the outer ring and which has a convex curved shape in axial cross-section;
the supply and discharge cavities are symmetrical with respect to a plane perpendicular to said axis;
the system comprises several fluid passages which are distributed around the axis;
the supply cavity is a single supply cavity which extends around the fluid passages;
the fluid passages are arranged between a first discharge cavity and a second discharge cavity;
the supply cavity is connected to the first and second discharge cavities by all the fluid passages;
the supply cavity is connected to the first discharge cavity by first fluid passages, and to the second discharge cavity by second fluid passages which are interposed between the first fluid passages;
the first and second discharge cavities are symmetrical with respect to a plane perpendicular to said axis;
each of the supply and discharge cavities forms or comprises one or more volute(s) about the axis;
each of the supply and discharge ducts extends mainly parallel to said axis;
the lubrication circuit is an oil circuit,
the cooling circuit is a fuel circuit,
the device comprises a heat exchanger comprising a first part connected to the lubrication circuit, and a second part connected to the cooling circuit, and configured to ensure an exchange of calories between the lubrication and cooling fluids.

The invention also relates to a gas generator, comprising at least one device as described above, the gas generator being for example a turbomachine or an auxiliary power unit.

### BRIEF DESCRIPTION OF THE FIGURES

Further characteristics and advantages will be apparent from the following description of a non-limiting embodiment of the invention with reference to the appended drawings wherein:

FIG. 1 is a very schematic view of a gas generator equipped with a guiding and cooling device according to the invention;

FIG. 2 is a schematic perspective view in axial cross-section of a guiding and cooling device, according to a first embodiment of the invention;

FIG. 3 is a schematic perspective view in axial cross-section of the guiding and cooling device shown in FIG. 2, without the rolling bearing and the shaft it guides;

FIG. 4 is a schematic perspective view in axial cross-section over 270° of the circulation volumes of the cooling fluid in the device shown in FIG. 2;

FIG. 5 is a schematic view in axial cross-section of the device of FIG. 2;

FIG. 6 is a schematic perspective view in axial cross-section of a guiding and cooling device, according to a second embodiment of the invention;

FIG. 7 is a schematic perspective view in axial cross-section of the guiding and cooling device shown in FIG. 6, without the rolling bearing and the shaft it guides;

FIG. 8 is a schematic view in axial cross-section of the device of FIG. 6;

FIG. 9 is a schematic perspective view cutaway in axial cross-section over 270° of the circulation volumes of the cooling fluid in the device shown in FIG. 6;

FIG. 10 is a schematic perspective view in partial axial cross-section over 270°, of the circulation volumes of the cooling fluid in the device shown in FIG. 6;

FIG. 11 is a schematic perspective view in axial cross-section of the circulation volumes of the cooling fluid in the device shown in FIG. 6;

FIG. 12 is a schematic perspective view in axial cross-section of a guiding and cooling device, according to a third embodiment of the invention;

FIG. 13 is a schematic perspective view in axial cross-section of the guiding and cooling device in FIG. 12, without the rolling bearing and the shaft it guides;

FIG. 14 is a schematic perspective view in axial cross-section over 270° of the circulation volumes of the cooling fluid in the device shown in FIG. 12;

FIG. 15 is a schematic view in axial cross-section of the device of FIG. 12;

FIG. 16 is a schematic perspective view in axial cross-section of a guiding and cooling device, according to a fourth embodiment of the invention;

FIGS. 17a to 17c are schematic views of annular cavities in the form of volute(s) of the guiding and cooling device according to the invention;

FIGS. 18a and 18b are very schematic views of the connection between a duct and an annular cavity of the guiding and cooling device according to the invention.

### DETAILED DESCRIPTION OF THE INVENTION

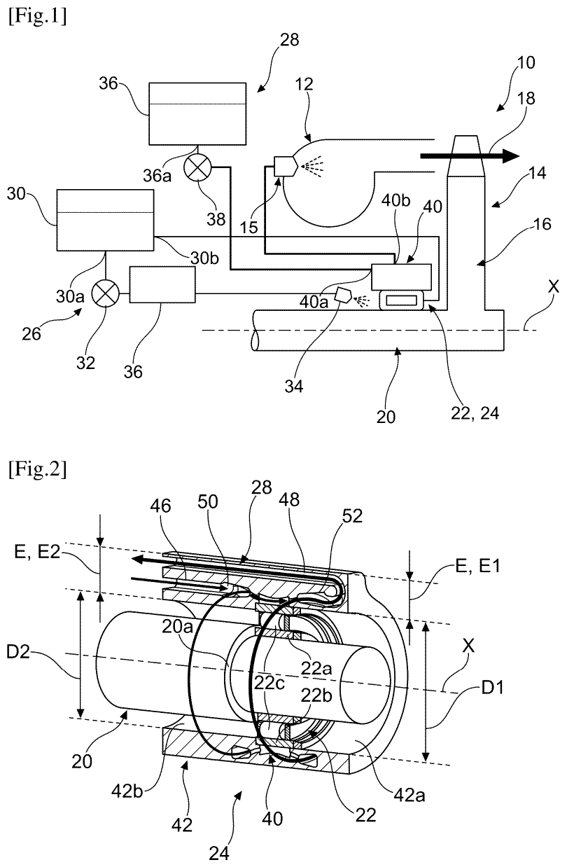

FIG. 1 is a very general and schematic representation of a gas generator 10, for example of a turbomachine or auxiliary power unit (APU), this turbomachine or this APU may be fitted to an aircraft, for example.

The gas generator 10 comprises at least one compressor (not shown), an annular combustion chamber 12 and at least one turbine 14. The combustion chamber 12 comprises fuel injectors 15.

The turbine 14 comprises a bladed rotor 16 which rotates inside a stator. The combustion gases 18 flowing through the vein of the turbine 14 expand and drive the rotor 16, which is connected to a shaft 20. This shaft 20 connects, for example, the rotor 16 of the turbine 14 to a rotor of the compressor.

The shaft 20 is centred and guided in rotation about an axis X by one or more roller bearings 22, for example ball or roller bearings.

In the context of the present invention, the rolling bearing 22 forms part of a guiding and cooling device 24 which also comprises a circuit 26 for lubricating the bearing and a bearing cooling circuit 28.

The lubrication circuit 26 is preferably an oil circuit. This circuit 26 comprises a reservoir 30 of lubricating fluid (oil), an outlet 30a of which is connected by a pump 32 to at least one oil nozzle 34, for example via an air/oil heat exchanger 36. The nozzle 34 is configured to spray oil onto the bearing 22. The reservoir 30 of the circuit 26 also comprises an inlet 30b connected to at least one oil recovery element at the level of the bearing 22.

The cooling circuit 28 is independent of the lubrication circuit 26 and preferably uses a different fluid, such as fuel. The circuit 28 comprises a cooling fluid or heat transfer fluid (fuel) reservoir 36, an outlet 36a of which is connected by a pump 38 to an inlet 40a of a system 40 for cooling the bearing 22. This system 40 comprises an outlet 40b which can be connected to the injector(s) 15, so that the fuel which has been used to cool the bearing 22 can subsequently be used to supply the combustion chamber 14.

The fuel is thus heated before being fed into the chamber 12, which is advantageous. In addition, the heat taken up by the fuel is not taken up by the oil, which is therefore less hot, which improves the efficiency of the lubrication and may make it possible to undersize the heat exchanger 36, in the sense of reducing the size of the exchanger.

The cooling system 40 also forms part, together with the bearing 22, of the guiding and cooling device 24 within the meaning of the invention.

In a particular embodiment of the invention, circuit 28 could also include a heat exchanger (not shown).

Although not visible in FIG. 1, the bearing 22 comprises two rings, an inner and an outer ring respectively, between which rolling elements such as balls or rollers are arranged. In the context of the present invention, the cooling system 40 is configured to cool the outer ring of the bearing 22 by allowing direct contact between the outer ring and the fuel and therefore a direct exchange of heat between them.

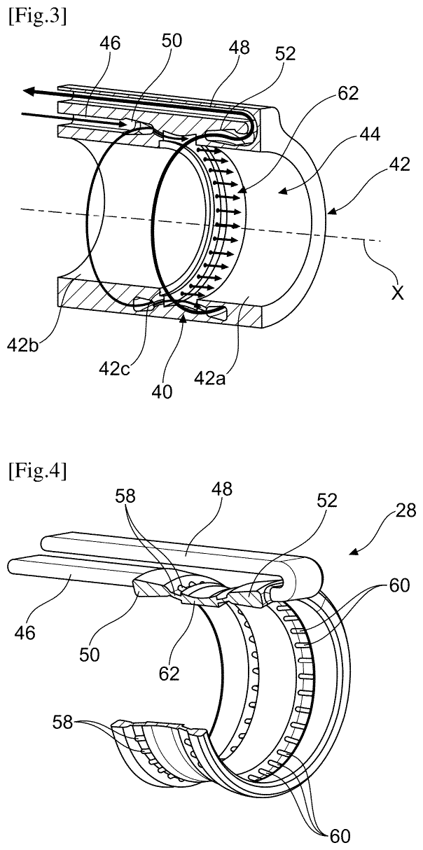

Reference is now made to FIGS. 2 to 5, which illustrate a first embodiment of the invention.

The guiding and cooling device 24 of FIGS. 2 to 5 comprises:
the rolling bearing 22 with its inner ring 22a, its outer ring 22b and its rolling elements 22c arranged between these rings 22a, 22b,
a lubrication circuit of the rolling bearing (not shown but corresponding, for example, to the circuit 26 in FIG. 6),
an annular casing 42 which extends around the bearing 22 and which comprises an internal recess 44 for mounting the outer ring 22b, this casing 42 comprising a wall thickness E measured radially with respect to the axis X, and
a circuit 28 for cooling the outer ring 22b of the bearing, which is independent of the lubrication circuit and is partly shown.

The wall thickness E of the casing 42 is not constant and can vary from a minimum thickness E1 to a maximum thickness E2.

In the example shown, the casing 42 comprises an internal cylindrical surface 42a which has a diameter D1 and an internal cylindrical surface 42b which has a diameter D2 smaller than D1. The recess 44 of the outer ring 22b is located inside the surface 42a, and in the vicinity of the junction between the surfaces 42a, 42b which forms an annular shoulder 42c against which the outer ring 22b is shaped to come to bear axially once installed. The inner ring 22a is mounted on the shaft 20 and can also bear axially against a shoulder 20a on the shaft 20. In the embodiment shown, the shaft 20 and the casing 42 are arranged axially with respect to each other so that the shoulders 20a, 42c lie in the same plane perpendicular to the shaft, the rings 22a, 22b having the same length in the axial direction. The rings 22a, 22b can be axially secured against the shoulders 20a, 42c by screwing nuts onto the shaft 20 and into the casing 42 respectively.

The cooling circuit 28 comprises:
at least one cooling fluid supply duct 46 and at least one cooling fluid discharge duct 48, formed in the wall thickness E of the casing 42,
at least one annular fluid supply cavity 50 extending around the axis X and formed in this wall thickness E, this annular cavity 50 being connected to the supply duct(s) 46,
at least one annular fluid discharge cavity 52 extending around the axis X and formed in this wall thickness E, this annular cavity 52 being connected to said discharge duct(s) 48, and
the annular system 40 for cooling the outer ring 22b, which is connected to the supply and discharge cavities 50, 52 respectively.

In the example shown, the circuit 28 comprises a single supply duct 46. This duct 46 has an elongated shape along the axis X and comprises a longitudinal end which is connected to the cavity 50 and opens into this cavity 50. As shown in FIG. 4, the cross-section of this duct 46, for example, is generally rectangular.

The supply cavity 50 is located on one side of the cooling system 40, and is more precisely arranged between the duct 46 and this system 40. As in the example shown, the cavity 50 may have a generally triangular or trapezoidal shape in axial cross-section and therefore have a fluid passage cross-section which changes along the axis X and in particular decreases along this axis, from the duct 46 to the system 40.

The discharge cavity 52 is located on the opposite side of the cooling system 40. As in the example shown, the cavity 50 may have a generally triangular or trapezoidal shape in axial cross-section and therefore have a fluid passage cross-section that changes along the axis X and in particular increases along this axis from the duct 46.

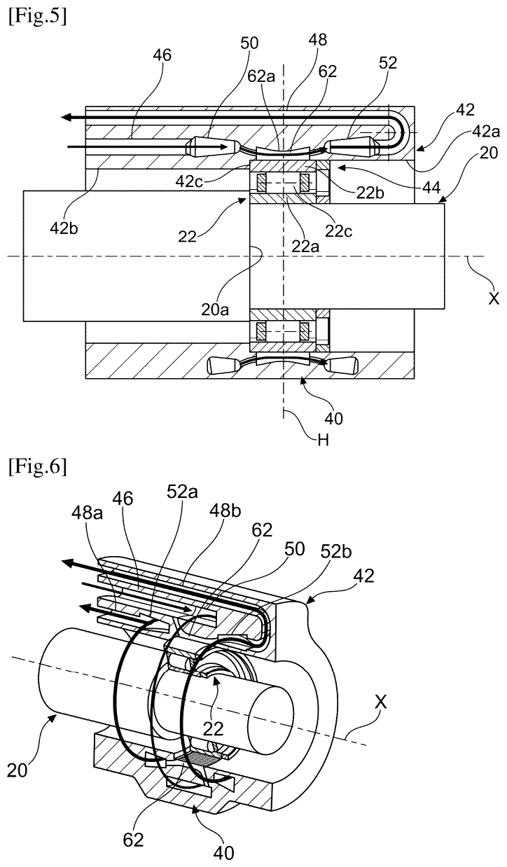

It can be seen from the drawings, and in particular FIG. 5, that the cavities 50, 52 can be symmetrical with respect to a plane H perpendicular to the axis X and passing between the cavities 50, 52 (FIG. 5).

In the example shown, the circuit 28 comprises a single exhaust duct 48. This duct 48 has an elongated shape along the axis and comprises a longitudinal end which is angled and connected to the cavity 52 and which opens into this cavity 52. As illustrated in FIG. 4, this duct 48 has, for example, a generally rectangular cross-sectional shape. The figures also show that the ducts 46, 48 can be arranged one above the other, and can therefore be intersected by the same plane passing through the axis X (FIG. 5).

The cavity 50 is connected to the cooling system 40 by a first series of orifices 58 which are preferably evenly distributed around the axis X. These orifices 58 are mainly oriented axially but may be inclined, for example in a tangential or radial direction. In the example shown, the orifices 58 are inclined radially inwards from their ends connected to the cavity 50 to their ends connected to the system 40.

The number of these orifices 58 is, for example, greater than 30.

The cavity 52 is connected to the cooling system 40 by a second series of orifices 60 which are preferably evenly distributed around the axis X. These orifices 60 are mainly oriented axially but may be inclined, for example in a tangential or radial direction. In the example shown, the orifices are inclined radially inwards from their ends connected to the cavity 52 to their ends connected to the system 40.

The orifices 58, 60 are also arranged symmetrically with respect to plane H (FIG. 5).

It can also be seen that the cavities 50, 52 each have a reduced passage cross-section around the axis X. It can be seen in FIG. 4 that these cavities 50, 52 have an axial dimension that decreases between 0° and 270° and then again until the annular element closes (i.e. on the rest of the circumference), so as to allow the supply pressures to be properly distributed in the orifices 58. If this were not the case, most of the fluid would pass through the orifices 50 opposite the supply 46.

According to the invention, the system 40 comprises at least one fluid passage 62 which extends along the axis X and opens radially inwards into the recess 44 of the outer ring 22b.

In the first embodiment, the system 40 comprises a single fluid passage 62 which has an annular shape around the axis X.

In the example shown, the passage 62 is located between the two cavities 50, 52, and is empty.

In the variant shown in the FIG. 16, this passage 62 is filled with a cellular or porous structure 64 of the lattice or lattice type, for example.

The passage 62 is delimited radially towards the outside by an annular base 62a which is intended to face the outer ring 22b of the bearing 22.

Advantageously, the axial cross-section of this bottom 62a is convexly curved, as shown in the drawings. This allows the fluid passage cross-section around the ring 22b to be reduced locally and accelerated in contact with the ring 22b to optimize the cooling of the latter. This also allows fuel stagnation areas inside the passage to be limited.

The inner periphery of the passage 62 is closed by the outer ring 22b of the bearing 22.

The plane H is also a plane of symmetry of the passage 62 (FIG. 5).

In the FIGS. 2, 3 and 5, the arrows show the flow of the cooling fluid (preferably fuel) in the circuit 28. The fluid flows axially over and in contact with the outer ring 22b, in particular in the passage 62. In the variant shown in FIG. 16, the cooling of the ring 22b by conduction is added to the cooling by convection when the structure 64 is in contact with the ring 22b inside the recess 44. In this structure 64, the path of the fluid can be sinuous on a very small scale, but its general orientation remains parallel to the axis X.

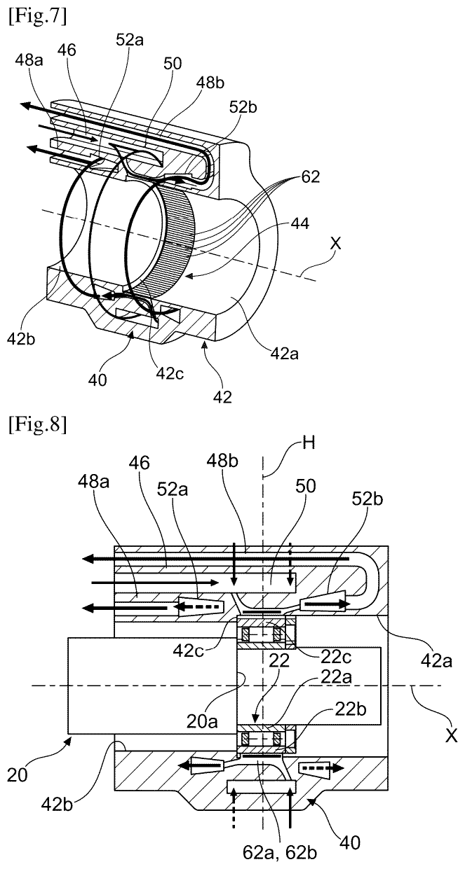

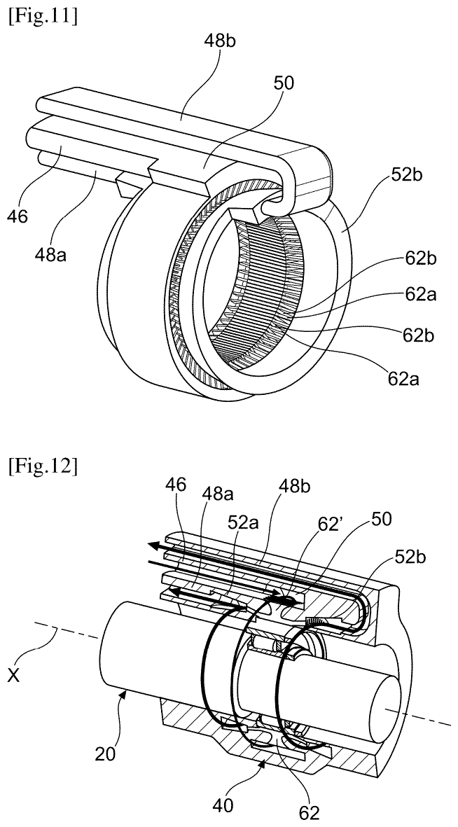

Reference is now made to FIGS. 6 to 11, which illustrate another embodiment of the invention.

As in the previous embodiment, the guiding and cooling device 24 comprises a rolling bearing 22, a lubrication circuit for the bearing (circuit not shown), an annular casing 42, and a circuit 28 for cooling the outer ring 22b of the bearing.

The following description focuses essentially on the technical differences between the embodiment shown in FIGS. 6 to 11 and that previously described, the other characteristics of these embodiments being identical or similar.

The circuit 28 comprises a single supply duct 46. This duct 46 has an elongated shape along the axis and comprises a longitudinal end which is connected to the cavity 50 and opens into this cavity 50. As shown in FIG. 4, the cross-section of this duct 46, for example, is generally rectangular.

The supply cavity 50 is located around the system 40. The cavity 50 may have a generally rectangular shape in axial cross-section.

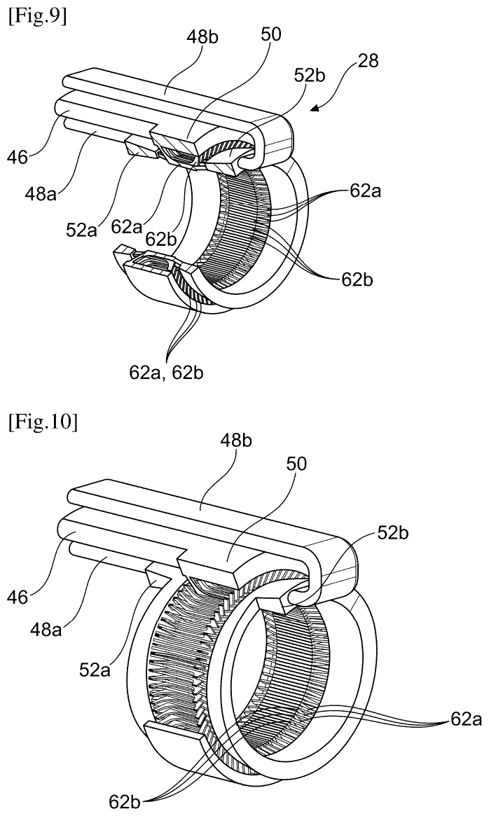

It can be seen that cavity 50 has a reduction in its passage cross-section around the axis X. FIGS. 9 to 11 show that this cavity 50 has a radial dimension which decreases between 0° and 270° and then again until the annular element is closed.

The circuit 28 comprises two evacuation cavities 52a, 52b which are located on either side of the cooling system 40.

Each of the cavities 52a, 52b may have a generally triangular shape in axial cross-section and therefore have a fluid passage cross-section which changes along the axis X.

It can also be seen that the cavities 52a, 52b each have a reduced passage cross-section around the axis X. FIGS. 9 to 11 show that these cavities 52a, 52b have an axial dimension which decreases between 0° and 270° and then again until the annular element is closed.

It can be seen from the drawings and in particular FIG. 58 that the cavities 52a, 52b can be symmetrical with respect to a plane H perpendicular to the axis X and passing between the cavities 52a, 52b (FIG. 8).

The circuit 28 comprises two exhaust ducts 48a, 48b. The ducts 48a, 48b are similar to the ducts 46, 48 described above. The duct 48a has an elongated shape along the axis and comprises a longitudinal end which is connected to the cavity 52a and opens into this cavity 52a. As shown in FIG. 9, the cross-section of this duct 48a, for example, is generally rectangular.

The duct 48b has an elongated shape along the axis and comprises a longitudinal end which is angled and connected to the cavity 52b and which opens into this cavity 52b. As shown in FIG. 9, the cross-section of this duct 48b, for example, is generally rectangular.

The figures also show that the ducts 46, 48a, 48b can be arranged one above the other, and can therefore be intersected by the same plane passing through the axis X (FIG. 8).

The cavity 50 is connected to the cavity 52a by first passages 62a which are distributed around the axis X. The cavity 50 is connected to the cavity 52b by second passages 62b which are distributed around the axis X. The passages 62a are inserted between the passages 62b.

The number of passages 62a is greater than 30, for example. For example, the number of passages 62b is greater than 30.

FIG. 9 shows in particular that each of the passages 62a, 62b is generally L-shaped and comprises a first branch with a principal axial orientation, which extends from the second branch as far as the cavity 52a or 52b, and a second branch with a principal radial orientation, which extends from the first branch outwards as far as the cavity 50.

Each of the passages 62a, 62b comprises a radially inner end which is closed by the outer ring 22b of the bearing 22.

In FIGS. 6 to 8, the arrows show the flow of the cooling fluid (preferably fuel) in the circuit 28. The fluid circulates axially on and in contact with the outer ring 22b, in particular in the first axial branches of the passages 62a, 62b. The circulations of the fluid in the passages 62a, 62b are advantageously in opposition.

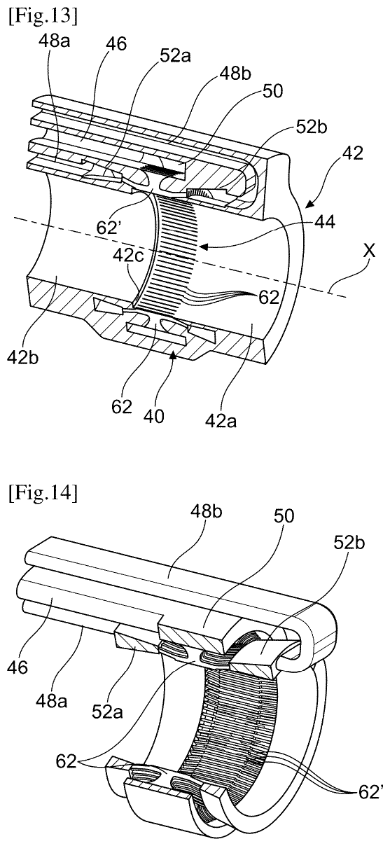

Reference is now made to FIGS. 12 to 15, which illustrate another embodiment of the invention.

This embodiment differs from the previous embodiment essentially in that the cavity 50 is connected to the cavities 52a, 52b by all the passages 62′. These passages 62′ are distributed around the axis X and are each, for example, generally T-shaped.

Each of the passages 62′ comprises a first branch with a main axial orientation, which extends between the cavities 52a, 52b and opens into these cavities 52a, 52b respectively, and a second branch with a main radial orientation, which extends from the middle of the first branch outwards as far as the cavity 50.

The number of passages 62′ is greater than 30, for example.

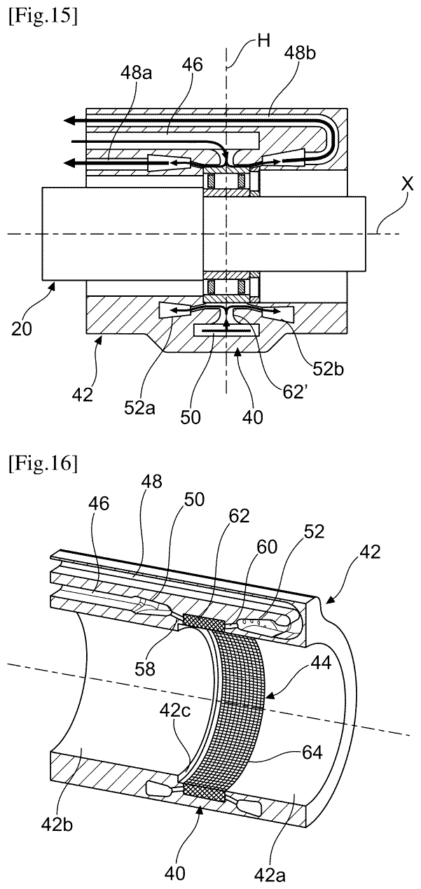

In FIGS. 12 and 15, the arrows show the flow of the cooling fluid (preferably fuel) in the circuit 28. The fluid flows axially over and in contact with the outer ring 22b, in particular in the first axial branches of the passages 62′. FIG. 15 shows that some of the fluid from the cavity 50 flows in a first direction along the axis X, from this cavity 50 to the cavity 52a, and some of the fluid from the cavity 50 flows in a second, opposite direction along the axis, from this cavity 50 to the cavity 52b.

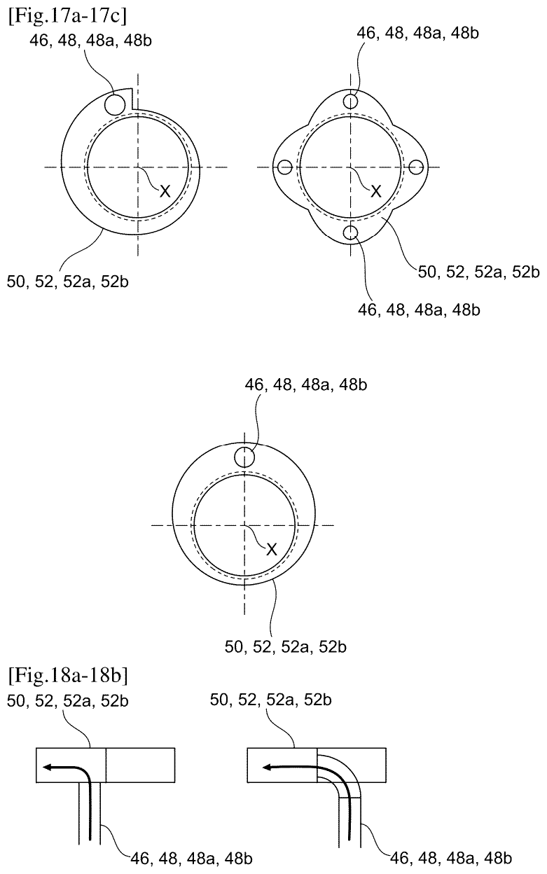

FIGS. 17a to 17c show particular ways in which the supply 50 and the discharge 52, 52a, 52b cavities are designed. Each of these cavities may comprise or form at least one volute, which extends around the axis X.

In the case of FIG. 17a, the cavity 50, 52, 52a, 52b comprises a single volute which extends over substantially 360° around the axis X. This volute has a passage cross-section which changes around the axis X and which is at its maximum where it is connected to the corresponding duct 46, 48, 48a, 48b, and which is at its minimum at the circumferential end of the volute opposite this duct.

Volutes of the type shown in FIG. 17a can be seen in FIGS. 9, 10, 11 and 14.

In the case of FIG. 17b, the cavity 50, 52, 52a, 52b comprises four volutes evenly distributed around the axis X and each having an angular extent of approximately 90° around this axis X. Each volute has a passage cross-section which is maximum at its centre, which is connected to the corresponding duct 46, 48, 48a, 48b, and which is minimum at its circumferential ends. The volutes are connected to each other by their circumferential ends.

In the case of FIG. 17c, the cavity 50, 52, 52a, 52b comprises a single volute extending over substantially 360° around the axis. This volute has a maximum passage cross-section at its centre, which is connected to the corresponding duct 46, 48, 48a, 48b, and a minimum at its circumferential ends. The circumferential ends of the volute are connected to each other.

The FIGS. 18a and 18b show respectively two configurations for connecting a duct 46, 48, 48a, 48b to a cavity 50, 52, 52a, 52b, in a device according to the invention. In FIG. 18a, the duct 46, 48, 48a, 48b is completely straight and opens axially into the cavity 50, 52, 52a, 52b. In FIG. 18b, the duct 46, 48, 48a, 48b has a bent end and opens in the circumferential direction into the cavity 50, 52, 52a, 52b.

Given the complexity of the casing 22 and the cooling circuit 28 which it partly contains, it could be produced by additive manufacturing.

1. A device for guiding a shaft about an axis and for cooling a bearing for a gas generator, the device comprising:
a rolling bearing centered on the axis and having an inner ring, an outer ring, and rolling elements arranged between the inner and outer rings;
a circuit for lubricating the rolling bearing;
an annular casing which extends around the bearing and which includes an internal recess for mounting the outer ring, the casing having a wall thickness measured radially with respect to the axis; and
a cooling circuit for cooling the outer ring of the bearing, which is independent of the lubrication circuit,
wherein the cooling circuit comprises:
at least one cooling fluid supply duct and at least one cooling fluid discharge duct, formed in the wall thickness of the casing;
at least one annular fluid supply cavity extending around the axis and formed in the wall thickness of the casing, the annular fluid supply cavity being connected to the at least one supply duct; 0
at least one annular fluid discharge cavity extending around the axis and formed in the wall thickness of the casing, the annular fluid discharge cavity being connected to the at least one discharge duct; and
an annular system for cooling the outer ring which is connected respectively to the annular fluid supply and discharge cavities, the annular system comprising at least one fluid passage which extends along the axis and which opens with a radial component inwards into the recess of the outer ring.

2. The device according to claim 1, wherein the system comprises a single fluid passage having an annular shape about the axis.

3. The device according to claim 2, wherein the single fluid passage is empty.

4. The device according to claim 2, wherein the single fluid passage is filled with a cellular structure.

5. The device according to claim 2, wherein the single fluid passage is connected to the annular fluid supply cavity by a first series of orifices formed in the annular casing, and to the annular fluid discharge cavity by a second series of orifices formed in the annular casing.

6. The device according to claim 2, wherein the single fluid passage comprises an annular bottom which faces the outer ring and which has a convex curved shape in axial cross-section.

7. The device according to claim 1, wherein the annular fluid supply and discharge cavities are symmetrical with respect to a plane perpendicular to the axis.

8. The device according to claim 1, wherein the system comprises several fluid passages which are distributed around the axis.

9. The device according to claim 8, wherein the annular fluid supply cavity is a single supply cavity which extends around the fluid passages.

10. The device according to claim 9, wherein the fluid passages are arranged between a first discharge cavity and a second discharge cavity.

11. The device according to claim 10, wherein the supply cavity is connected to the first and second discharge cavities by all of the fluid passages.

12. The device according to claim 10, wherein the supply cavity is connected to the first discharge cavity by first fluid passages, and to the second discharge cavity by second fluid passages which are interposed between the first fluid passages.

13. The device according to one claim 10, wherein the first and second discharge cavities are symmetrical with respect to a plane perpendicular to the axis.

14. The device according to claim 1, wherein each of the annular fluid supply and discharge cavities forms or comprises one or more volutes about the axis.

15. A gas generator comprising at least one device according to claim 1, wherein the gas generator is a turbomachine or an auxiliary power unit.
